(19) United States
(12) Patent Application Publication
(10) Pub. No.: US 2005/0259092 A1
(43) Pub. Date: Nov. 24, 2005

(54) Image-correction-amount detecting device, circuit for driving electro-optical device, electro-optical device, and electronic apparatus

(75) Inventor: Toru Aoki, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/091,386

(22) Filed: Mar. 29, 2005

(30) Foreign Application Priority Data
May 20, 2004 (JP) 2004-150460
Mar. 8, 2005 (JP) 2005-063477

(51) Int. Cl. G09G 3/36

(52) U.S. Cl. 345/204

(57) ABSTRACT

An image-correction-amount detecting device includes an image signal generation unit, a luminance detecting unit, and a correction value calculation unit. The image signal generation unit generates and supplies image signals having inverted polarities to a display section in which pixels are formed so as to correspond to intersections of a plurality of scanning lines and a plurality of source lines which are arranged in a matrix and which performs pixel display by allowing an image signal supplied to a source line to be applied to a pixel electrode of each pixel via switching elements, the image signal being supplied to the source line by turning on a switching element disposed in the pixel with the scanning signal supplied to the scanning line. The luminance detecting unit detects the luminance of each pixel position of an image displayed by the display section. While changing the reference voltage which is set in the display section, the correction value calculation unit calculates the difference of the luminance between a positive polarity image signal and a negative polarity image signal in each pixel position, calculates the distribution of reference voltages in the display section which applies the minimum luminance difference, and outputs an image correction amount to obtain the optimal reference voltage that matches the effective value of the positive polarity image signal with the effective value of the negative polarity image signal.

### BACKGROUND OF THE INVENTION

1. Technical Field

The present invention relates to an electro-optical device in which flicker or the like can be reduced over the entire display region, a circuit for driving the same, and an electronic apparatus.

2. Related Art

Electro-optical devices, for example, such as liquid crystal display devices using liquid crystal as an electro-optical material are widely used, as display devices replacing cathode ray tubes (CRTs), for display units or liquid crystal TVs in, for example, various information processing apparatuses.

Such a liquid crystal display device includes, for example, pixel electrodes arranged in a matrix, an element substrate on which switching elements such as thin film transistors (TFTs) connected to the pixel electrodes are disposed, a counter substrate on which counter electrodes corresponding to the pixel electrodes are disposed, and liquid crystal as the electro-optical material filled between these two substrates.

The TFTs are electrically connected to each other by scanning signals (gate signals) supplied via scanning lines (gate lines). When the switching elements are in an electrically conductive state after the scanning signals are applied thereto, an image signal with a voltage in response to a gray-scale level is applied to the pixel electrode via the data line (source line). Then, charge is stored in the pixel electrode and the counter electrode in response to the voltage of the image signal. Even when the scanning signal is removed to make the TFT be in the non-electrically conductive state after charges are stored, the charge storage state at each electrode is maintained by the capacitance of the liquid crystal layer or storage capacitor.

As such, when each switching element is driven to control the amount of charge to be stored in response to the gray-scale level, the orientation state of the liquid crystal at each pixel is changed to allow the transmittance of light to be changed, which in turn allows the brightness to be changed at each pixel. Accordingly, it is possible to perform display in response to the gray-scale level.

However, direct current components of applied signals cause the liquid crystal display device to be contaminated due to impurities within liquid crystal cells or cause liquid crystal components to break down, and cause a burn-in phenomenon of the display image to occur. In this case, reverse driving, in which the polarity of the voltage for driving each pixel electrode is generally inverted for every frame of the image signal, is performed. Surface-reverse driving such as the frame reverse driving is performed with driving voltages whose polarities are equal to each other for all pixel electrodes constituting the image display region to invert the driving voltage for a constant period.

In consideration of the capacitances of the storage capacitor and the liquid crystal layer, charge may be applied to the liquid crystal layer of each pixel only for a portion of the period. Accordingly, when the plurality of pixels arranged in a matrix are driven, scanning signals may be simultaneously applied to the pixels connected to the same scanning line via respective scanning lines, and the image signals may be applied to each pixel via the data lines, and the scanning line for supplying the image signal may be sequentially switched to the next one. That is, the scanning line and the data line may be used in common for the plurality of pixels of the liquid crystal display device, which allows time-division multiplex driving to be implemented.

As such, in consideration of the capacitance in the liquid crystal display device, the driving voltage is applied to the pixel only for a portion of the period. However, the pixel electrode is affected by the potential of the source line due to the charge leakage and the coupling capacitance even when the TFT is in an off state. Due to the potential variation of the voltage applied to the pixel, the display within the screen is not uniform, and the image quality is significantly degraded in the intermediate gray-scale region.

To avoid such a problem, a reverse driving technique is employed, which is combined with reverse driving processing per frame and line reverse driving for making the polarities of the driving potentials different from each other from line to line in the liquid crystal display device. The polarity of the image signal transmitted via the source line is converted in a relatively short period so that the effects of coupling capacitance and charge leakage may be reduced. Here, the polarity of the image signal refers to a relative polarity based on an LC common voltage, which is a reference voltage.

However, the image signal supplied via the source line is applied to the pixel electrode via the source and drain path of the TFT. As described above, when the TFT is turned off, the level of the image signal applied to the pixel electrode is lowered to be retained due to the capacitor and the capacitance of the liquid crystal layer until the next writing is carried out. However, at the time of the TFT being turned off, the voltage applied to the pixel electrode is lowered by the voltage retained in the interconnection capacitance and the parasitic capacitance between the gate and source of the TFT, which is so called push-down. Furthermore, due to the channel effect of the TFT, the amount of push-down right after the writing of the negative polarity image signal is larger than that right after the writing of the positive polarity image signal.

Due to such a differential amount of push-down, the effective value of the positive polarity image signal and that of the negative polarity image signal become changed. In general, a voltage applied to the counter electrode (hereinafter, referred to as an LC common voltage) is set to a level where the effective value of the positive polarity image signal matches that of the negative polarity image signal so as not to apply a direct current component to the liquid crystal layer. That is, the more the amount of push-down is increased, the more the LC common voltage for matching the effective value of the positive polarity image signal with that of the negative polarity image signal is decreased.

However, the Y driver for supplying the scanning signal to each scanning line is disposed at one side or both sides of the pixel region in the liquid crystal display device. The waveform of the scanning signal is distorted due to an interconnection resistance or the like when the distance of the pixel having the scanning signal applied from the Y driver is increased. As a result, the more the distance from the Y driver is increased, the less the amount of push-down is decreased. That is, the difference between the amount of push-down of the positive polarity and that of the negative polarity is increased when the distance of the pixel from the Y driver is increased and vice versa. That is, the optimal LC common voltage is changed in response to the screen position.

In addition, the TFT substrate and the counter substrate which constitute the liquid crystal display device generally have a stacked structure, and light components incident on the liquid crystal display device at an angle are subjected to multiple reflection within the stacked structure so that they are irradiated on the channel region or the region adjacent to the channel region of the TFT element. As a result, an optical leakage current occurs, which flows toward the gate of the TFT element. The leakage current lowers the level of the positive polarity image signal and maintains the level of the negative polarity image signal. Furthermore, the effect of the optical leakage current is more significant at the time of positive polarity driving than the negative polarity driving. That is, the optimal LC common voltage is lowered due to the occurrence of leakage current.

However, a center portion of an opening region and the surrounding portion have a different amount of optical leakage from each other: the amount of optical leakage increases towards the center of the screen. That is, the optimal LC common voltage is changed depending on the screen position.

The LC common voltage is a voltage applied to the common electrode, and is uniform within the screen. Accordingly, the effective value of the voltage applied to the liquid crystal capacitance is actually changed at the time of positive polarity writing and the negative polarity writing due to the effects of push-down and optical leakage in response to the screen position. As a result, regardless of the alternative current driving, a direct current component is applied to the liquid crystal capacitance, which causes the burn-in phenomenon to occur and causes flicker to occur at the time of positive polarity writing and the negative polarity writing so that the display quality becomes significantly degraded.

### SUMMARY

An advantage of the invention is that it provides an image-correction-amount detecting device which can calculate the image correction amount of image signal for obtaining an electro-optical device that reduces the deterioration of display quality caused by burn-in or flicker.

An image-correction-amount detecting device according to an aspect of the invention includes: an image signal generation unit that generates and supplies image signals having inverted polarities to a display section in which pixels are formed so as to correspond to intersections of a plurality of scanning lines and a plurality of source lines which are arranged in a matrix and which performs pixel display by allowing an image signal supplied to a source line to be applied to a pixel electrode of each pixel via switching elements, the image signal being supplied to the source line by turning on a switching element disposed in the pixel with the scanning signal supplied to the scanning line; a luminance detecting unit that detects the luminance of each pixel position of an image displayed by the display section; and a correction value calculation unit that, while changing the reference voltage which is set in the display section, calculates the difference of the luminances between a positive polarity image signal and a negative polarity image signal in each pixel position, calculates the distribution of reference voltages in the display section which applies the minimum luminance difference, and outputs an image correction amount to obtain the optimal reference voltage that matches the effective value of the positive polarity image signal with the effective value of the negative polarity image signal.

According to this configuration, the image signal generation unit generates the image signals with the inverted polarities to supply to the display section. The luminance detecting unit detects the luminance for each pixel position of the image which is displayed by the display section. The correction value calculation unit calculates the luminance difference between the positive polarity image signal and the negative polarity image signal for each pixel position, while changing the reference voltage which is set in the display section. By changing a reference voltage, it is possible to match the effective values of the positive polarity image signal and the negative polarity image signal which are supplied to the display section. When the effective values matches with each other, the luminance difference decreases. In other word, a reference voltage at which the luminance difference decreases is a voltage of which a direct current of the image signal supplied to the display section is made 0. The correction value calculation section calculates the distribution of reference voltages in the display section, corresponding to the minimum luminance difference, and output the image correction amount to obtain the optimal reference voltage which matches the effective value of the positive polarity image signal with the effective value of the negative polarity image signal. By using the image correction amount, the direct current of image signal supplied to the display section is controlled, which makes it possible to perform a high-quality image display which does not cause any burn-in or flicker.

In addition, the image correction amount is a value which is obtained by calculating the difference between a set reference voltage set in another display section having the same configuration as the display section and a reference voltage corresponding the minimum luminance difference, for every pixel.

According to this configuration, by using the image correction amount which minimizes the difference between the luminance of positive polarity image signal and the luminance of negative polarity image signal, it is possible to perform a high-quality image display which does not cause any burn-in or flicker.

In addition, the luminance detecting unit detects the luminance for a portion of pixel positions of the image and the correction value calculating unit interpolates the luminance detected by the luminance detecting unit to obtain the luminance value for all pixel positions of the image.

According to this configuration, by the interpolation processing with respect to the results of detecting the luminance of a few pixel positions, it is possible to calculate the luminance value for all pixels and to obtain the image correction amount enabling a correction having high precision with small calculation amount.

In addition, the image signal generating unit supplies an image signal which performs one of an intermediate gray-scale display and a black display to a pixel driven with a positive polarity and also supplies an image signal which performs the remaining of an intermediate gray-scale display and a black display to a pixel driven with a negative polarity, within a frame.

According to this configuration, a change of polarity of the image signal driving each pixel and a change of polarity of the image signal match with each other, which makes it possible to easily determine flicker according to the result detected by the luminance detecting unit. In addition, a change of luminance with respect to a change of image signal is large in the intermediate gray-scale display, which makes it possible to reliably determine flicker.

According to another aspect of the invention, a circuit for driving an electro-optical device includes: a storage unit that stores information of the image correction amount for minimizing flicker; and a correction unit that supplies the image signals corrected on the basis of the information of the image correction amount which is calculated by the image-correction-amount detecting device according to the above aspect of the invention and stored in the storage unit, to a display section in which pixels are formed so as to correspond to intersections of a plurality of scanning lines and a plurality of source lines which are arranged in a matrix and which performs pixel display by allowing an image signal supplied to a source line to be applied to a pixel electrode of each pixel via switching elements, the image signal being supplied to the source line by turning on a switching element disposed in the pixel with the scanning signal supplied to the scanning line.

In this configuration, the storage unit stores the image correction amount for minimizing flicker. The correction unit corrects the input image signals using the image correction amount to apply to the display section. As a result, flicker is suppressed in the image displayed in the display section, which makes it possible to ensure a high-quality image display.

According to another aspect of the invention, an electro-optical device includes: a display section in which pixels are formed so as to correspond to intersections of a plurality of scanning lines and a plurality of source lines which are arranged in a matrix and which performs pixel display by allowing an image signal supplied to a source line to be applied to a pixel electrode of each pixel via switching elements, the image signal being supplied to the source line by turning on a switching element disposed in the pixel with the scanning signal supplied to the scanning line; and a circuit for driving the electro-optical device according to the aspect of the invention that supplies the image signals to the display section.

According to this configuration, the image signals for suppressing flicker are supplied to the display section, which make it possible to display a high-quality image without flickering.

In addition, an electric apparatus according to the aspect of the invention includes a display device using the above-described electro-optical device.

According to this configuration, since the image signals supplied to the display section is signals for minimizing flicker, a high-quality image display without flickering can be provided in the display device.

### BRIEF DESCRIPTION OF THE DRAWINGS

The invention will be described with reference to the accompanying drawings, wherein like numbers reference like elements, and wherein:

FIG. 1 is a block diagram illustrating an image-correction-amount detecting device according to an embodiment of the invention;

FIG. 2 is an explanatory view illustrating an electro-optical device;

FIG. 3 is a block diagram illustrating an electrical configuration of a projector;

FIG. 4 is a block diagram illustrating the configuration of a liquid crystal panel 100R;

FIG. 5 is a timing chart illustrating an operation of the projector;

FIG. 6 is an explanatory view illustrating disposed luminance meters on the screen;

FIG. 7 is a block diagram illustrating a transmittance characteristic of a liquid crystal panel;

FIG. 8 is an explanatory view for explaining an image signal for detecting luminance;

FIG. 9 is a flow chart illustrating a correction value calculation operation;

FIG. 10 is a perspective view illustrating the configuration of a computer; and

FIG. 11 is a perspective view illustrating the configuration of a cellular phone.

### DESCRIPTION OF THE EMBODIMENTS

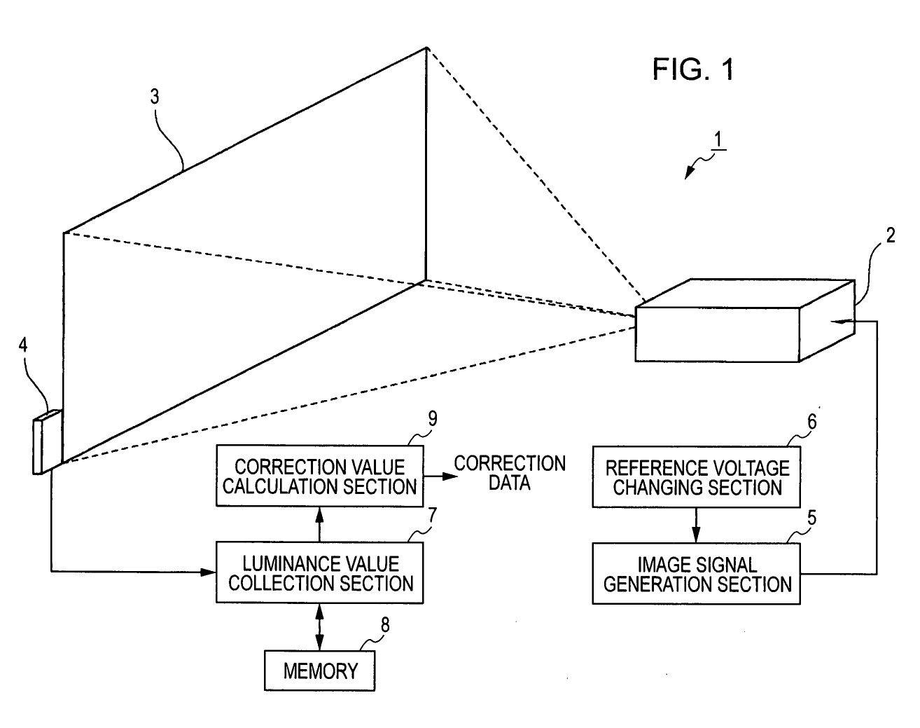

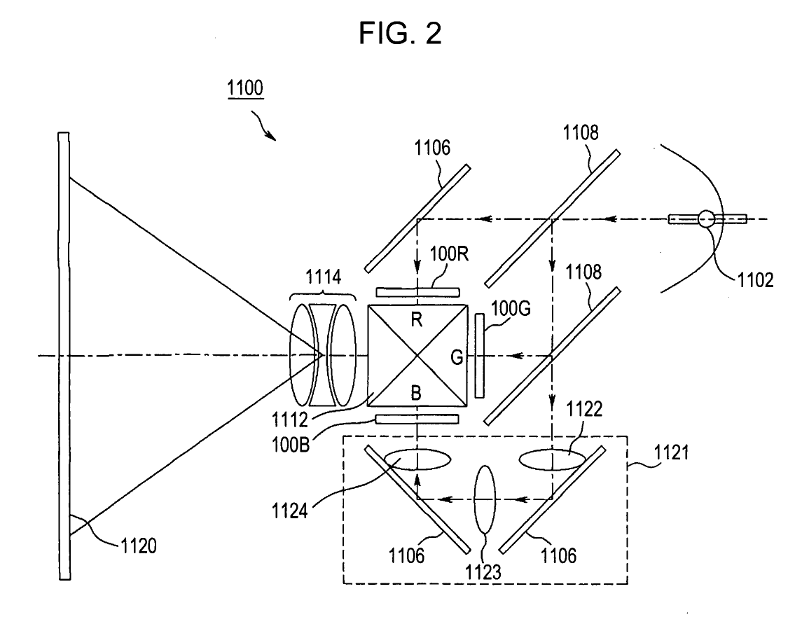

Preferred embodiments of the invention will now be described with reference to the drawings. FIG. 1 is a block diagram illustrating an image-correction-amount detecting device according to an embodiment of the invention. In addition, FIG. 2 is an explanatory view illustrating an electro-optical device which uses an image correction amount calculated by the present embodiment. The present embodiment refers to detection of the image correction amount in a projector which combines images transmitted by liquid crystal panels, and then enlarges and projects the combined image.

### Embodiments

First, a configuration of an optical system of the projector, which uses the image correction amount calculated by the embodiment, will be schematically described with reference to FIG. 2.

Referring to FIG. 2, a lamp unit 1102 composed of a white light source such as a halogen lamp is disposed within a projector 1100. Projection light emitted from the lamp unit 1102 is separated into three primary colors of red (R), green (G), and blue (B) by three internal mirrors 1106 and two internal dichroic mirrors 1108; the separated light is then guided to liquid crystal panels 100R, 100G, and 100B corresponding to the respective primary colors.

In this case, image signals of the R, G, and B colors processed by a processing circuit 300 to be described later are supplied to the liquid crystal panels 100R, 100B, and 100G, respectively. Accordingly, the liquid crystal panels 100R, 100B, and 100G serve as optical modulators for generating the images of the primary colors of R, G, and B. Light components modulated by the liquid crystal panels 100R, 100B, and 100G are incident on the dichroic prism 1112 from the three o'clock direction. The R and B light components are refracted while the G light component propagates straight through the dichroic prism 1112. As a result, the combined image of the respective color images is projected onto the screen 1120 via the projection lens 1114. In addition, light components corresponding to the primary colors R, G, and B are made incident on the respective liquid crystal panels 100R, 100B, and 100G by the dichroic mirror 1108, so that a color filter such as a direct view panel is not necessary.

Next, the electrical configuration of the projector 1100 will be described.

FIG. 2 is a block diagram illustrating the electrical configuration of the projector. The projector 1100 has three liquid crystal panels 100R, 100G, and 100B, a timing control circuit 200, and a processing circuit 300. Among these components, the timing control circuit 200 generates clock signals or timing signals for controlling respective components in response to a vertical scanning signal Vs, a horizontal scanning signal Hs, and a dot clock signal DCLK supplied from a higher-level device.

Meanwhile, the processing circuit 300 includes a ROM 321, a gamma correction circuit 310, a correction circuit 320, S/P (serial-parallel) conversion circuits 330R, 330G, and 330B, and inverting amplifying circuits 340R, 340G, and 340B. Among these components, the gamma correction circuit 310 performs gamma correction on the supplied digital image data DR, DG, and DB corresponding to the R, G, and B components so as to make them correspond to the respective display characteristics of the liquid crystal panels 100R, 100G, and 100B so that the image data DR′, DG′, and DB′ are output. The correction circuit 320 performs correction on the image data DR′, DG′, and DB′ per color or per pixel for preventing flicker from occurring while converting the corrected data to be output as image signals VIDR, VIDG, and VIDB.

The ROM 321 stores image-correction-amount data for preventing a burn-in phenomena as well as minimizing flicker, that is, an image correction amount calculated by the image-correction-amount detecting device of FIG. 1. The correction circuit 320 corrects image data using the image correction amount stored in the ROM 321. For example, the correction circuit 320 adds the image correction amount for each pixel calculated by the image-correction-amount detecting device to the input image data DR′, DG′, and DB′ for each pixel to correct it.

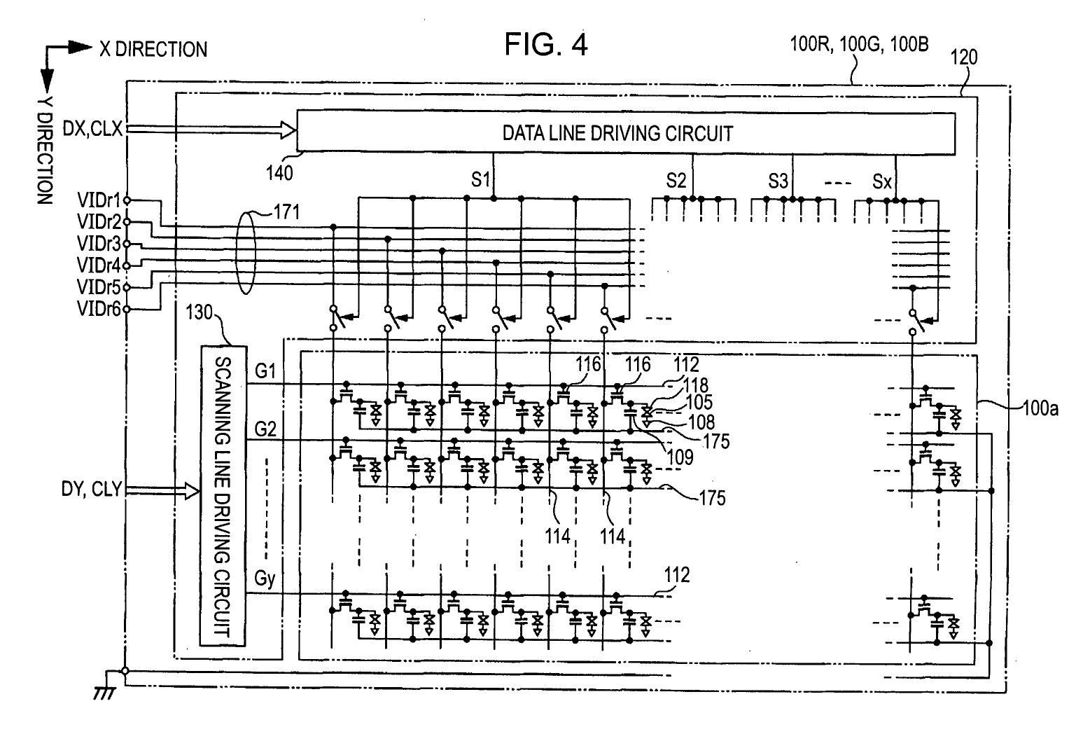

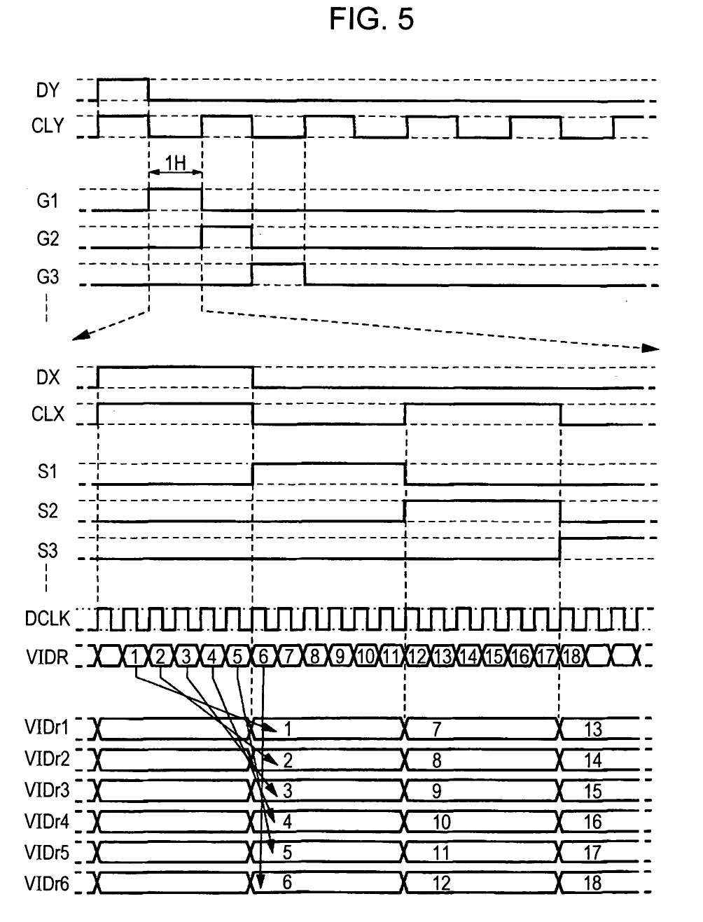

When the image signal VIDR of one line is input, the S/P conversion circuit 330R corresponding to the color R distributes it to six lines and expands (i.e., serial-parallel conversion) it by six times with respect to the time axis, to output the image signal VIDR of one line (See FIG. 5). In this case, the conversion to image signals of six lines is performed in order to lengthen the time for applying the image signal to ensure a sufficient sampling time and charge and discharge time of the image signal in the sampling switch 151, to be described later (see FIG. 4). The inverting amplifying circuit 340R corresponding to color R inverts and amplifies the polarity of the image signal to be supplied to the liquid crystal panel 100R as image signals VIDr1 to VIDr6. On the whole, a polaritiy of the image signal refers to a relative polarity based on an LC common voltage, which is a reference voltage.

In addition, the image signal VIDG of color G output from the correction circuit 320 is similarly converted to six lines by the S/P conversion circuit 330G, and is inverted and amplified by the inverting amplifying circuit 340G to be supplied to the liquid crystal panel 100G as image signals VIDg1 to VIDg6. Similarly, the image signal VIDB of the color blue (B) is converted to six lines by the S/P conversion circuit 330B, and is inverted and amplified by the inverting amplifying circuit 340B to be supplied to the liquid crystal panel 100B as image signals VIDb1 to VIDb6. Here, the polarity of the image signal refers to a relative polarity based on an LC common voltage, which is a reference voltage.

In addition, the inverting amplifying circuits 340R, 340G, and 340B perform polarity inversion by alternately inverting a voltage level, with a constant potential Vc of the voltage serving as a reference. In addition, performing the inversion is determined by the manner of applying the image signal to the data line on a scanning line basis, data line basis, or a pixel basis, and its inversion period is set to one horizontal scanning period or the dot clock period. It is hereinafter assumed that the manner is based on the scanning lines for simplicity of description.

Next, the configuration of the liquid crystal panels 100R, 100G, and 100B will be described.

The liquid crystal panels 100R, 100G, and 100B have the same electrical configuration as each other, so that the liquid crystal panel 100R corresponding to the color R will be described as an example in the present embodiment. FIG. 4 is a block diagram illustrating the configuration of the liquid crystal panel 100R. As shown in FIG. 4, a plurality of scanning lines 112 are arranged in the row (X) direction and a plurality of data lines 114 are arranged in the column (Y) direction in the display region 100a of the liquid crystal panel 100. At each intersection between the data lines 112 and the data lines 114, the gate of the TFT 116 serving as a switching element is connected to the scanning line 112 and the source of the TFT 116 is connected to the data line 114, while the drain of the TFT 116 is connected to the rectangular transparent pixel electrode 118. In this case, the pixel electrode 118 faces the counter electrode 108, and the liquid crystal 105 is interposed between these electrodes. That is, the liquid crystal capacitance is formed by interposing the liquid crystal between the pixel electrode and the counter electrode.

A scanning line driving circuit 130, a data line driving circuit 140, and a peripheral circuit 120 composed of sampling switches 151 or the like are disposed in the peripheral region of the display region 100a. Among these components, the scanning line driving circuit 130 sequentially shifts the transmitting pulse DY supplied at the time of initiating the vertical scanning period whenever the logical level of the clock signal CLY transits (rising and falling), and supplies the scanning signals G1, G2, G3, . . . , Gy, which are exclusively turned on, to each scanning line 112 for each horizontal scanning period 1H, as shown in FIG. 5.

The data line driving circuit 140 outputs the sampling control signals S1, S2, . . . , Sx, which have sequentially turned-on potentials, within one horizontal scanning period. In detail, the data line driving circuit 140 sequentially shifts the transmitting pulse DX supplied at the time of initiating the vertical scanning period whenever the logical level of the clock signal CLX transits, and outputs sampling control signals S1, S2, S3, . . . , Sx so as to make them exclusively have a turned-on potential, as shown in FIG. 5.

The image signals VIDr1 to VIDr6 are supplied via six image signal lines 171 and sampled to each data line 114 in response to the sampling control signals S1, S2, . . . , Sx. In detail, every six data lines 114 forms one block, and the sampling switch 151 connected to one end of the data line 114 that is positioned at the farthest left among six data lines 114 included in the i-th (i=1, 2, . . . , n) block when counted from left of FIG. 4 samples the image signal VIDr1 supplied via the image signal line 171 to be supplied to the corresponding data line 114 when the sampling signal Si is turned on.

In addition, the sampling switch 151 connected to one end of the second data line 114 among six data lines 114 included in the same i-th (i=1, 2, . . . , n) block samples the image signal VIDr2 to be supplied to the corresponding data line 114 when the sampling signal Si is turned on. Similarly, the sampling switches 151 connected to respective one ends of the third, fourth, fifth, and sixth data lines 114 among six data lines 114 included in the same i-th block sample the image signals VIDr3, VIDr4, VIDr5, and VIDr6 to be supplied to the corresponding data lines 114 when the sampling signal Si is turned on.

In addition, the capacitor 109 for contributing to charge accumulation of the liquid crystal capacitance is disposed in parallel with each liquid crystal capacitance in the display region 100a. In detail, one end of the capacitor 109 is connected to the pixel electrode 118 (drain of TFT 116) while the other is connected by the capacitor line 175 in common. In addition, the capacitor line 175 is grounded to a constant potential (for example, potential LCcom, on-potential Vdd, off-potential Vss or the like) in common.

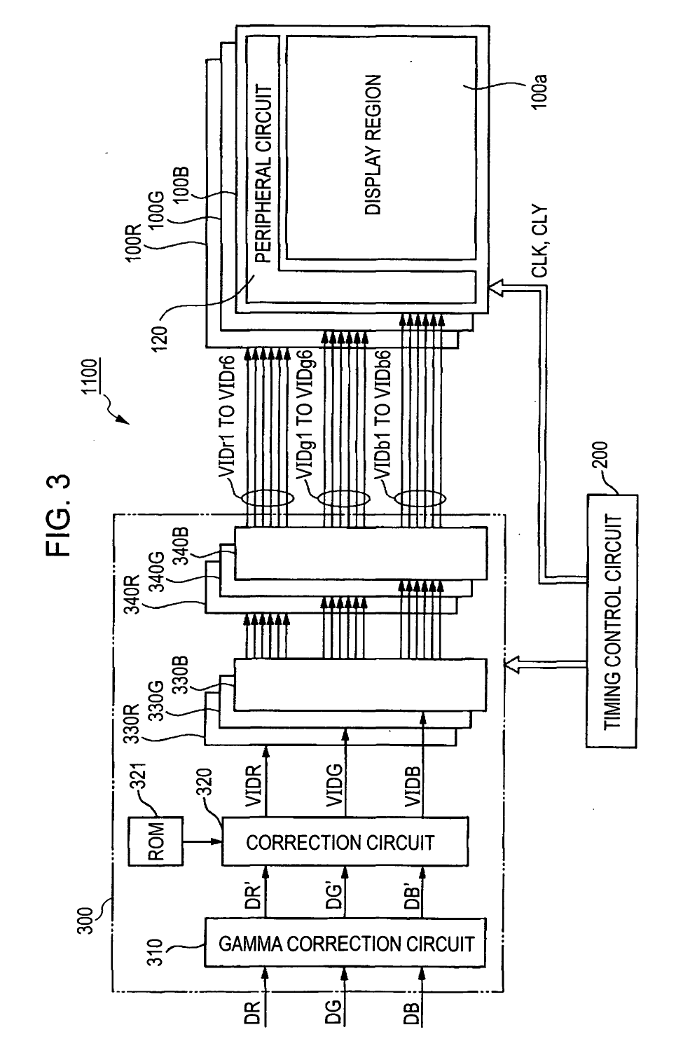

Referring to FIG. 1, an image-correction-amount detecting device 1 includes a projector 2 having the same configuration as that of FIG. 2. In addition, the projector 2 may be configured to be of the same three-panel as that of FIG. 2, and also may be configured as a monochrome single-panel type with one liquid crystal panel. The projector 2 is configured so as to have a liquid crystal panel having the same configuration (not shown) as that of a liquid crystal panel 100 whose image correction amount is detected as described above. In addition, the projector 2 is configured with a correction circuit 320 omitted from FIG. 3, regardless of whether it is a single-panel type or a three-panel type. In the projector 2, an LC common voltage, which is a reference voltage supplied to a common electrode on a counter substrate (not shown) constituting the liquid crystal panel 100, may be changed by external control.

A reference voltage changing section 6 may preferably change the LC common voltage of the projector 2. An image signal generation section 5 is configured so as to generate a predetermined image signal of a test image and to supply it to the projector 2. The liquid crystal panel 100 is driven based on the LC common voltage set by the reference voltage changing section 6 and the image signal of the input test image, so that the projector 2 may enlarge and project the test image onto a screen 3.

In addition, the LC common voltage of the projector 2 may be fixed, a set value of the reference voltage of the reference voltage changing section 6 may be provided to the image signal generation section 5, and the reference voltage of the image signal of the test image in the image signal generation section 5 may be supplied to the projector 2 while the reference voltage is changed.

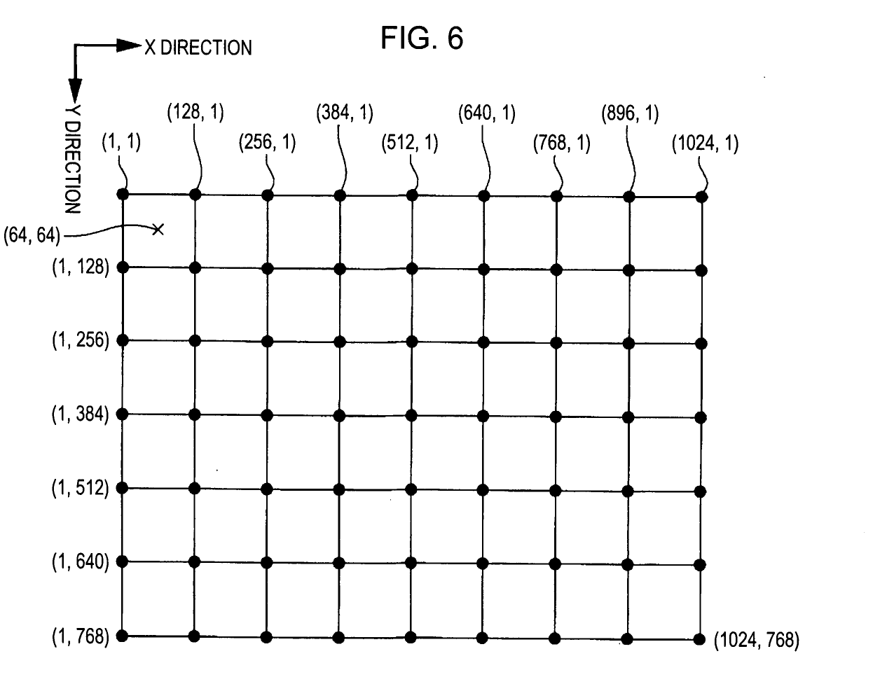

FIG. 6 is an explanatory view illustrating the configuration of the screen 3 of FIG. 5.

A plurality of luminance meters are mounted on a surface of the screen 3. For example, in the case where the liquid crystal panel 100 has a resolution of 1024×768, the luminance meters are arranged on the screen 3, which are marked by black circles for every 9×7 display positions corresponding to the 128×128 pixels of the liquid crystal panel 100.

Each of the luminance meters on the screen 3 is driven by a luminance meter driving section 4, and the luminance meter driving section 4 outputs a luminance value for each point on the screen 3 which is calculated by each of the luminance meters to a luminance value collection section 7.

The luminance value collection section 7 stores in a memory the reference voltage value together with the luminance value from the luminance meter driving section 4 according to the positive image signal and the negative image signal for all types of test images. The luminance value collection section 7 outputs a result of collecting the luminance values to a correction value calculation section 9.

The correction value calculation section 9 calculates the luminance value in each set state for each pixel other than pixels of the liquid crystal panel 100 corresponding to the disposed position of the luminance meters through interpolation processing, according to the arranged positions of the luminance meters on the screen 3 and the luminance values collected based on the disposed positions.

Also, the correction value calculation section 9 compares the luminance based on the positive image signal with the luminance based on the negative image signal, for every pixel of the liquid crystal panel 100, based on the calculated luminance value corresponding to the positions. Then, the correction value calculation section 9 calculates a reference voltage for minimizing the difference between the two luminance values. The correction value calculation section 9 calculates the distribution of reference voltages for minimizing the difference between the two luminance values, in pixel units of the liquid crystal panel 100.

The correction value calculation section 9 calculates for every pixel the difference between the reference voltages calculated by minimizing the difference between luminance values and the reference voltage (hereinafter, referred to as a set reference voltage) set as the LC common voltage of the projector in FIG. 2, and the calculated result is used as an image correction amount for every pixel position. The image correction amount calculated by the correction value calculation section 9 is supplied to the correction circuit 320 of FIG. 3 as correction data.

Further, the correction value calculation section 9 calculates the image correction amount for every pixel of the liquid crystal panel 100, but may calculate an image correction amount for each predetermined region. Even in this case, the correction value calculation section 9 can correct a change of optimal LC common voltage within the display region 100a to a certain degree.

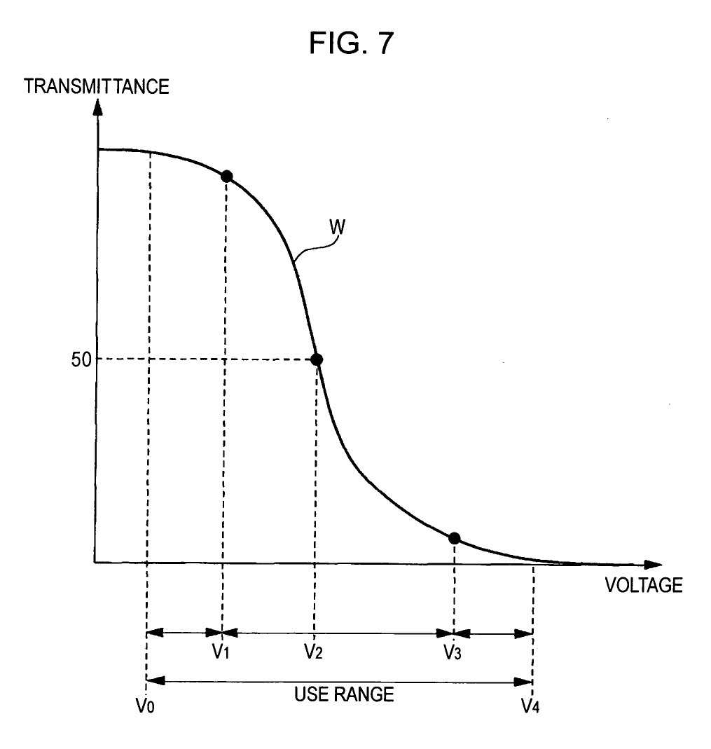

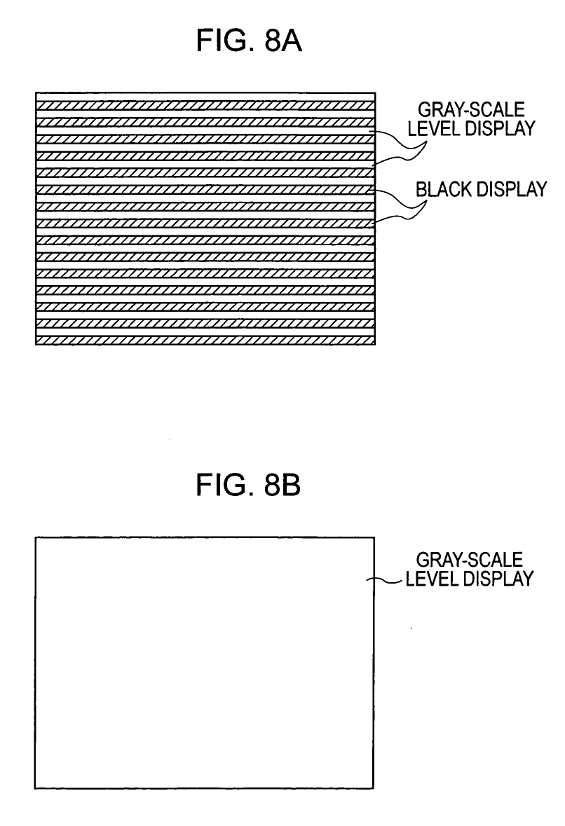

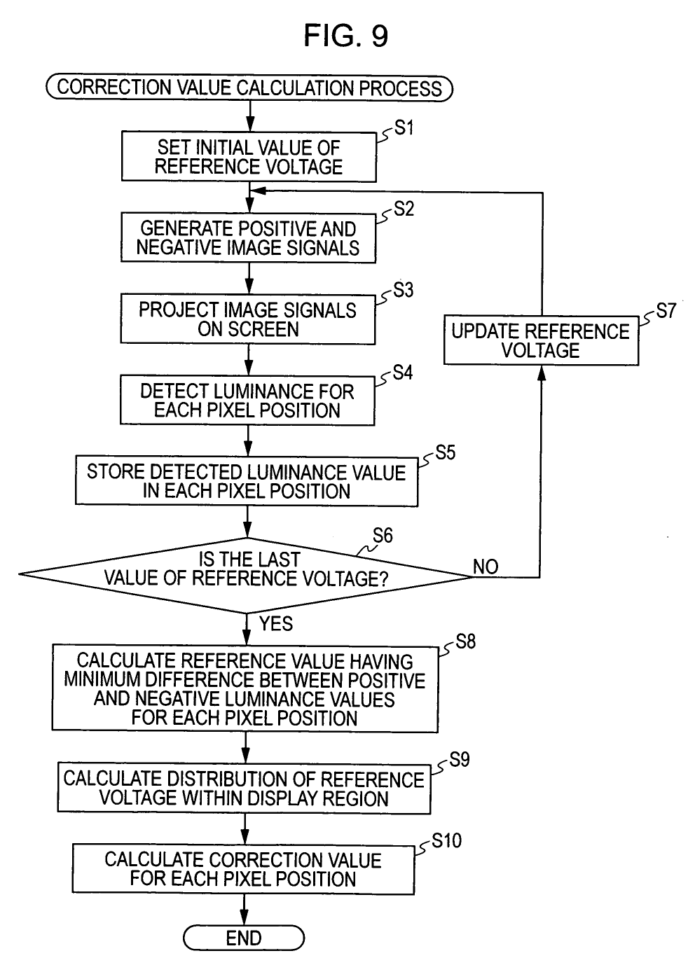

Next, an operation of image correction amount calculation will be described with reference to FIG. 7 to FIG. 9. FIG. 7 is a block diagram illustrating a voltage transmittance characteristic, in which the horizontal axis indicates the driving voltage of the liquid crystal and the traverse axis indicates the transmittance of the liquid crystal. FIG. 8 is an explanatory view illustrating a test image. In addition, FIG. 9 is a flow chart illustrating correction value calculation processing.

As described above, an optimal LC common voltage for each position within the display region 100a differs due to the effects of push-down and optical leakage. In the projector of FIG. 3, the LC common voltage is set to a fixed set reference voltage and the image correction amount calculated by the image-correction-amount detecting device of FIG. 1 is added to the image signal for each region of the display region 100a, so that the optimal LC common voltage can be obtained equivalently for the entire the display region 100a.

The image signal generation section 5 supplies an image signal of the test image shown in FIG. 8A or 8B to the projector 2. FIG. 8A illustrates a test pattern in which an intermediate gray-scale display and a black display change for every line, and FIG. 8B illustrates a test pattern of a level such that the intermediate gray-scale level is uniform over the entire region.

As shown in FIG. 7, a change of transmittance with respect to a change of driving voltage is relatively large in a voltage range corresponding to an intermediate gray-scale level, that is, in a peripheral range of driving voltage V2 among effective ranges V1 to V3 of the driving voltage (image signal) of the liquid crystal. Thus, it is easy to confirm a change of luminance by adopting a test image of intermediate gray-scale level.

In the case of 1H reverse driving, the positive image signal and the negative image signal are written alternately for every line. Accordingly, when the test image shown in FIG. 8A is adopted, a change of image and a change of polarity of the image signal match with each other, to easily confirm the existence of flicker. In the embodiment, flicker is detected by the luminance meter, but adopting a pattern of FIG. 8 makes it easy to perform numeric conversion of the flicker according to a detection result of the luminance meter, even though the luminance meter measures the luminance of a region including a plurality of pixels. In addition, adopting a raster pattern in FIG. 8B makes it possible to easily check for flicker in the case of 1V reverse driving.

Further, an example of the raster pattern is shown in FIG. 8, in the case of 1H reverse driving in which the positive polarity driving and the negative polarity driving switch over for every line. However, as a reverse driving, various patterns of surface reverse driving, such as 2H reverse driving or dot reverse driving or the like, are taken into consideration. In these cases, an intermediate gray-scale display or a black display need not be performed respectively in the pixel driven with positive polarity and the pixel driven with negative polarity, respectively, within a frame.

For example, an intermediate gray-scale display is performed in the pixel driven with positive polarity and a black display is performed in the pixel driven with negative polarity. Then, a luminance level based on the intermediate gray-scale display of the pixel driven with positive polarity is obtained according to a result measured by a luminance meter, even though the luminance for each predetermined region is measured by the luminance meter. Further, on the contrary, when the black display is performed in the pixel driven with positive polarity and the intermediate gray-scale display is performed in the pixel with negative polarity, a luminance level based on the intermediate gray-scale display of the pixel driven with the negative polarity is obtained.

Accordingly, using the test pattern of FIG. 8 makes it possible to respectively acquire the luminance level in the case of positive polarity driving and in the case of negative polarity driving. Further, in field reverse driving, a pixel driven with the positive polarity in a predetermined field is driven with the negative polarity in the next field and a pixel driven with the negative polarity in a predetermined field is driven with the positive polarity in the next field. Accordingly, in this case, it is possible to obtain the luminance level in the case of the positive polarity driving and the luminance level in the case of the negative polarity driving, according to the measurement result in two fields.

Further, although an example in FIG. 8A, in which the intermediate gray-scale display or the black display is performed, was described, the black display is not necessarily performed, and a display close to black, in which a change of luminance with respect to driving signal is relatively small, may be performed.

The image signal generation section 5 can output the test image of FIGS. 8A and 8B, for example, while inverting the image by 1H and, further, can output the image while inverting the image by 1H and 1V.

The reference voltage changing section 6 changes the reference voltage set in the common electrode of the projector 2 within a predetermined range, for each predetermined control unit. For example, the reference voltage changing section 6 changes the reference voltage by one bit LSB (the least significant bit) of the image signal input in the projector, when the image signal is digitally processed.

In step S1 of FIG. 9, the reference voltage changing section 6 sets the reference voltage at a predetermined initial value. The image signal generation section 5 generates the test image of FIGS. 8A and 8B to supply it to the projector 2 (step S2). The projector 2 adopts the set reference voltage as the LC common voltage, drives each pixel of the liquid crystal panel 100 with the input test image, and outputs the projected image onto the screen 3 (step S3).

In the step S4, each of the luminance meters arranged on the screen 3 detects the luminance of each point on the projected image during the driving period of the positive polarity signal and during the driving period of the negative polarity signal. The luminance meter driving section 4 outputs the luminance value calculated by each of the luminance meters to the luminance value collection section 7. The luminance value collection section 7 stores in the memory 8 the information of the disposed position of each of the luminance meters together with the luminance value calculated by each of the luminance meters for each type of test image and each reference voltage (step S5).

The reference voltage changing section 6 updates reference voltages in step S7, when all reference voltages to be set in step S6 are not yet set. In this case, the steps S2 to S5 are repeatedly performed on the updated reference voltages, so that the calculated luminance value for each type of test image and each reference voltage is stored together with information of the disposed position of each of the luminance meters in the memory 8.

When the processing of steps S2 to S5 with respect to all the reference voltages to be set is completed, the luminance value collection section 7 supplies a result of collecting the luminance values to the correction value calculation section 9. In step S8, the correction value calculation section 9 calculates the reference voltage at which the luminance value based on the positive polarity signal and the pixel value based on the negative polarity signal for each pixel position become minimum (flicker is minimized).

Further, as described above, the correction value calculation section 9 may calculate the luminance value by interpolating based on all pixels other than the pixels of liquid crystal panel 100 corresponding to the disposed position of the luminance meters, using the luminance value for the disposed position of the luminance meters. In this case, the reference voltage at which flicker is minimized can be calculated for all pixels of the liquid crystal panel 100.

Next, the correction value calculation section 9 calculates the distribution of reference voltages within the display region at which flicker is minimized, in step S9. The correction value calculation section 9 calculates for each pixel the difference between the reference voltage at which flicker is minimized and a predetermined set reference voltage, to adopt it as the correction value (the image correction amount) for each pixel position.

The correction value calculation section 9 supplies the image correction amount to the correction circuit 320 of FIG. 3. The correction circuit 320 adds the image correction value to the input image signal. As a result, the LC common voltage becomes equivalent to the optimal LC common voltage to prevent a direct-current component from being applied to the liquid crystal.

As such, according to the embodiment, the image correction amount based on the change of the optimal LC common voltage within the surface for each pixel position is obtained by calculating the luminance based on the positive polarity image signal and the luminance based on the negative polarity image signal for each pixel position. The image correction amount calculated in the embodiment is added to the positive polarity image signal and the negative polarity image signal, so that the positive effective value is made equivalent to the negative effective value and the set LC common voltage becomes equivalent to the optimal LC common voltage for all pixels. As a result, the deterioration of display quality caused by the burn-in phenomenon or flicker can be suppressed.

Electronic Apparatus

Next, an example in which the above-described processing circuit is applied to an electronic apparatus other than the projector will be described.

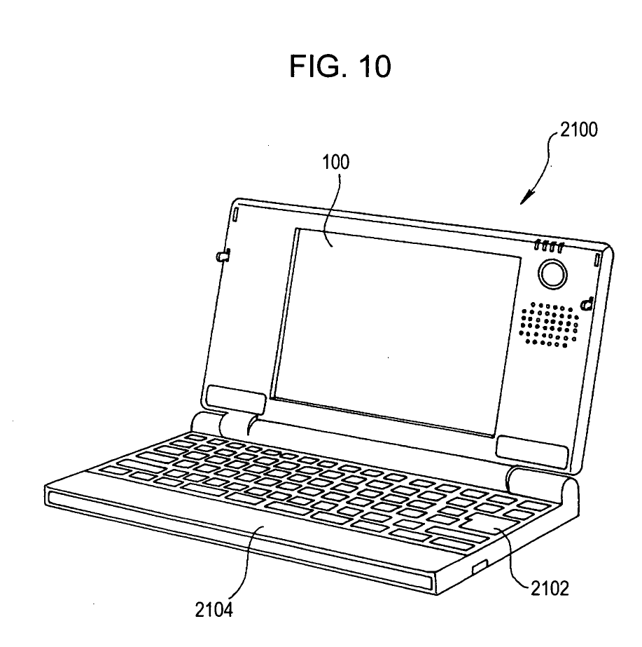

First, an example in which the above-described processing circuit is applied to the display section of the mobile computer will be described. FIG. 10 is a perspective view illustrating the configuration of the computer. Referring to FIG. 10, the computer 2100 includes a main body 2104 having a keyboard 2102, and a liquid crystal panel 100. In addition, a backlight unit for enhancing the visibility (not shown) is disposed on the rear surface of the liquid crystal panel 100.

In this case, the above-described projector 1100 has three plates of liquid crystal panels 100R, 100G, and 100B corresponding to respective colors, however, the liquid crystal panel 100 has a color filter to display each color. Accordingly, the image signals VIDr1 to VIDr6, VIDg1 to VIDg6, and VIDb1 to VIDb6 are not parallel supplied to the liquid crystal panel 100 but in time-division manner. In this case, as is done with the above-described correction circuit 320, the same correction is performed on the positive polarity image signal and the negative polarity image signal in response to distance from the center of the display region, so that a burn-in phenomena and flicker may be properly reduced over the whole display region.

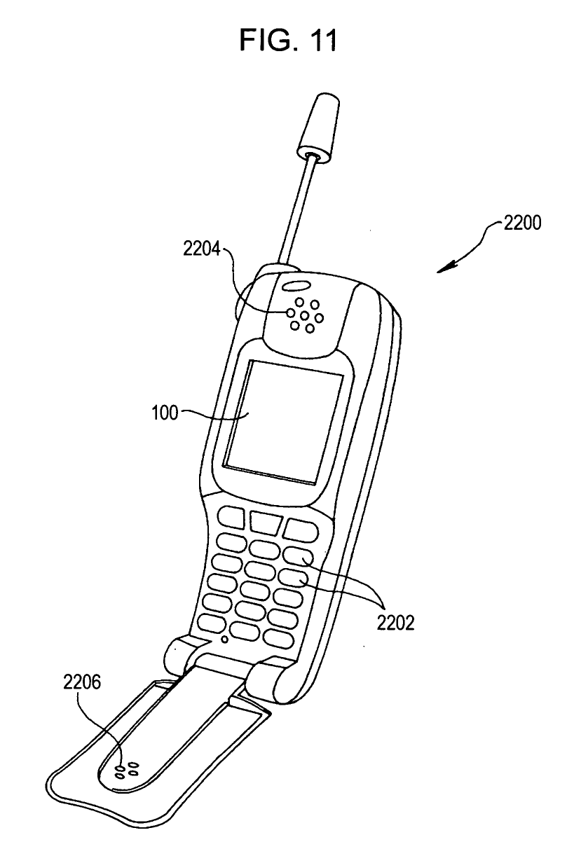

Next, an example which has applied the above-described processing circuit to a display section of a cellular phone is described. FIG. 11 is a perspective view illustrating a configuration of the cellular phone. Referring to FIG. 11, the cellular phone 2200 has a plurality of manipulating buttons 2202, a receiver 2204, a sender 2204, and a liquid crystal panel 100 used as the display section. The liquid crystal panel 100 displays each color of Red, Green, and blue colors (RGB) using a color filter, however, it may perform the gray-scale display of the white color only. When the gray-scale display is carried out for the white color, the image process circuit has not components for three primary colors but a component for a single color.

In addition to the electronic apparatuses described with reference to FIGS. 10 and 11, a liquid crystal TV, view-finder type, or monitor direct view type video tape recorder, a car navigation device, a pager, an electronic note, a calculator, a word processor, a workstation, a picture phone, a point of sale (POS) terminal, a device having a touch panel, and so forth may be employed. And the invention may also be applied to these various electronic apparatuses.

1. An image-correction-amount detecting device comprising:
an image signal generation unit that generates and supplies image signals having inverted polarities to a display section in which pixels are formed so as to correspond to intersections of a plurality of scanning lines and a plurality of source lines which are arranged in a matrix and which performs pixel display by allowing an image signal supplied to a source line to be applied to a pixel electrode of each pixel via switching elements, the image signal being supplied to the source line by turning on a switching element disposed in the pixel with the scanning signal supplied to the scanning line;
a luminance detecting unit that detects the luminance of each pixel position of an image displayed by the display section; and
a correction value calculation unit that, while changing a reference voltage which is set in the display section, calculates the difference of the luminance between a positive polarity image signal and a negative polarity image signal in each pixel position, calculates the distribution of reference voltages in the display section, corresponding to the minimum luminance difference, and outputs an image correction amount to obtain the optimal reference voltage that matches the effective value of the positive polarity image signal with the effective value of the negative polarity image signal.

2. The image-correction-amount detecting device according to claim 1,
wherein the image correction amount is a value which is obtained by calculating, for every pixel, the difference between a set reference voltage set in another display section having the same construction as the display section and the reference voltage corresponding the minimum luminance difference.

3. The image-correction-amount detecting device according to claim 1,
wherein the luminance detecting unit detects luminance for some of the pixel positions of the image, and the correction value calculating unit interpolates the luminance detected by the luminance detecting unit to obtain luminance values for all the pixel positions of the image.

4. The image-correction-amount detecting device according to claim 1,
wherein the image signal generating unit supplies an image signal which performs one of intermediate gray-scale display and black display to a pixel driven with a positive polarity and also supplies an image signal which performs the other of the intermediate gray-scale display and the black display to a pixel driven with a negative polarity, within a frame.

5. A circuit for driving an electro-optical device comprising:
a storage unit that stores information of the image correction amount for minimizing flicker; and
a correction unit that supplies the image signals corrected on the basis of the information of the image correction amount which is calculated by the image-correction-amount detecting device according to claim 1 and stored in the storage unit to a display section, in which pixels are formed so as to correspond to intersections of a plurality of scanning lines and a plurality of source lines which are arranged in a matrix and which performs pixel display by allowing an image signal supplied to a source line to be applied to a pixel electrode of each pixel via switching elements, the image signal being supplied to the source line by turning on a switching element disposed in the pixel with the scanning signal supplied to the scanning line.

6. An electro-optical device comprising:
a display section in which pixels are formed so as to correspond to intersections of a plurality of scanning lines and a plurality of source lines which are arranged in a matrix and which performs pixel display by allowing an image signal supplied to a source line to be applied to a pixel electrode of each pixel via switching elements, the image signal being supplied to the source line by turning on a switching element disposed in the pixel with the scanning signal supplied to the scanning line; and
a circuit for driving the electro-optical device according to claim 5 that supplies the image signals to the display section.

7. An electrical apparatus which includes a display device using the electro-optical device according to claim 6.
